(19) United States
(12) Patent Application Publication
(10) Pub. No.: US 2025/0376330 A1
(43) Pub. Date: Dec. 11, 2025

(54) TOOL UTILIZING VACUUM RETENTION AND METHOD OF USE THEREOF

(71) Applicant: JR Automation Technologies, LLC, Holland, MI (US)

(72) Inventors: Joseph Peter Fodrocy, Grand Haven, MI (US); Granite Harris Kirby Winowiecki, Wyoming, MI (US); Steven Michael Morehouse, Holland, MI (US); Calen Fraser Ducham, West Olive, MI (US)

(21) Appl. No.: 19/235,540

(22) Filed: Jun. 11, 2025

Related U.S. Application Data
(60) Provisional application No. 63/658,852, filed on Jun. 11, 2024.

(51) Int. Cl. B65G 17/32; B25J 15/06; B65G 17/34

(52) U.S. Cl. CPC B65G 17/323; B65G 17/34; B25J 15/0616

(57) ABSTRACT

A tool utilizing vacuum retention. The comprises a housing and a movable fan assembly with at least one fan. The movable fan assembly is configured to move the at least one fan in fluid communication with at least one fan opening on the housing to generate vacuum to pick up and retain an outside component on a surface of the housing. The movable fan assembly is further configured to move the at least one fan out of fluid communication with the at least one fan opening on the housing to remove the vacuum to release the outside component from the surface of the housing. The tool may be attached to an outside structure such as a conveyor system or an end of a robotic arm.

### CROSS-REFERENCE TO RELATED APPLICATION

This application claims priority to and the benefit of U.S. Provisional Patent Application No. 63/658,852 filed on Jun. 11, 2024, the entire content of which is incorporated by reference herein.

### BACKGROUND OF THE DISCLOSURE

### 1. Field of the Disclosure

The disclosure relates in general to component handling, and more particularly, to a tool utilizing vacuum retention and method of use thereof.

### 2. Background Art

Using vacuum to retain components such as workpieces is known in industrial manufacturing and processing. Vacuum retention leverages the creation of a pressure differential to hold objects securely in place, providing a relatively reliable method for handling outside components. This technique can be beneficial in applications where other retention methods may damage the outside component or are impractical due to complex geometries of the outside component, for example.

Vacuum retention systems typically involve the use of vacuum pumps or generators connected to a sealed chamber where the outside component is positioned. When air is evacuated from the chamber, atmospheric pressure exerts a uniform force on the outside component, holding it firmly against the fixture. This method allows for even distribution of force, minimizing the risk of deformation or damage. These methods can create a satisfactory vacuum, however, it may come at high cost, payload, and power consumption, amongst other issues.

### SUMMARY OF THE DISCLOSURE

In an aspect, the disclosure includes a tool utilizing vacuum retention that comprises a housing and at least one fan assembly. The housing includes a plenum, at least one fan opening and a surface comprising a plurality of openings configured to engage an outside component utilizing vacuum retention. The outside component may include a thin material or textile. The plenum, in some configurations, may be defined by stacking a back plate having the at least one fan opening, a spacer plate and a part holding plate having the surface comprising the plurality of openings. The at least one fan assembly is mounted to the housing and comprises at least one fan mounted on a movable shuttle. In some configurations, the least one fan may be powered by wireless power transmission. The movable shuttle may move along a pair of guide rails, that are spaced apart and mounted in parallel on an outer surface of the back plate, in response to force exerted by an actuator. The movable shutter may be configured to position the at least one fan in fluid communication with the at least one fan opening to engage the outside component utilizing vacuum retention. The movable shuttle may be further configured to place the at least one fan out of fluid communication with the at least one fan opening to disengage the outside component. The at least one fan may be placed in and out of fluid communication with the at least one fan opening via lateral displacement in some configurations.

The housing, in some configurations, may comprise a mounting assembly to facilitate attachment of the tool to an outside structure such as a conveyor system or end of a robotic arm. The tool may be movable during operation of the at least one fan.

In another aspect, the disclosure includes a method of utilizing vacuum retention. The method comprises generating vacuum through a vacuum plate with at least one fan mounted on a movable shuttle, configuring the movable shuttle to position the at least one fan over at least one fan opening so that the at least one fan is in fluid communication with the at least one fan opening and retaining an outside component with the vacuum that is generated. The outside component may include a thin material or textile in some configurations. The method may further comprise stopping vacuum generation through the vacuum plate by configuring the movable shuttle to position the at least one fan out of fluid communication with the at least one fan opening and releasing the outside component from vacuum plate. In some configurations, the movable shutter may move along a pair of guide rails that are spaced apart and mounted on an outer surface of the back plate in response to force exerted by an actuator. The at least one fan may be placed in and out of fluid communication with the at least one fan opening via lateral displacement. The at least one fan may be powered by wireless power transmission.

The vacuum plate includes a plurality of openings. A housing may comprise a plenum defined by a spacer plate sandwiched in between the vacuum plate and a back plate having the at least one fan opening and a mounting assembly. The housing may be movable during the operation of the at least one fan. The method may further comprise attaching the housing to an outside structure, such as a conveyor system or end of a robotic arm, using the mounting assembly.

In a further aspect, the disclosure includes a conveyor system utilizing a tool utilizing vacuum retention. The conveyor system may include a conveyor and a tool utilizing vacuum retention movable along the conveyor. The tool may comprise a housing and a movable fan assembly having at least one fan. The movable fan assembly may be configured to move the at least one fan in fluid communication with at least one fan opening on the housing to generate vacuum to pick up and retain an outside component on a surface of the housing, and out of fluid communication with the at least one fan opening on the housing to remove the vacuum to release the outside component from the surface of the housing. The at least one fan may be placed in and out of fluid communication with the at least one fan opening via lateral displacement. The at least one fan may be powered by wireless power transmission.

Various other aspects, configurations and advantages of the disclosed tool, method and conveyor system will be apparent from the following description and the appended claims.

### BRIEF DESCRIPTION OF THE DRAWINGS

The disclosure will now be described with reference to the drawings wherein:

FIG. 1 of the drawings is a part holding plate side perspective view of the tool using vacuum retention of the present disclosure;

FIG. 2 of the drawings is a mounting plate side perspective view of the tool using vacuum retention of the present disclosure;

FIG. 3 of the drawings is a cross-sectional perspective view of the tool using vacuum retention of the present disclosure, taken generally about lines 3-3 of FIG. 2;

FIG. 4 of the drawings is a plan view of the part holding plate side of the tool using vacuum retention of the present disclosure;

FIG. 5 of the drawings is a cross-sectional view of the tool using vacuum retention of the present disclosure, taken generally about lines 5-5 of FIG. 4;

FIG. 6 of the drawings is a cross-sectional view of the tool using vacuum retention of the present disclosure, taken generally about lines 6-6 of FIG. 4;

FIG. 7 of the drawings is a perspective view of the back plate of the housing of the tool using vacuum retention of the present disclosure;

FIG. 8 of the drawings is a perspective view of the spacer plate of the housing of the tool using vacuum retention of the present disclosure;

FIG. 9 of the drawings is a perspective view of the part holding plate of the housing of the tool using vacuum retention of the present disclosure;

FIG. 10a of the drawings is a top plan view of the first fan of the fan assembly of the tool using vacuum retention of the present disclosure;

FIG. 10b of the drawings is a side elevational view of the first fan of the fan assembly of the tool using vacuum retention of the present disclosure;

FIG. 11a of the drawings is a back plate side perspective view of the tool using vacuum retention of the present disclosure, depicting the fan assembly in an extended or closed configuration;

FIG. 11b of the drawings is a back plate side perspective view of the tool using vacuum retention of the present disclosure, depicting the fan assembly in a retracted or open configuration;

FIG. 12 of the drawings is a partial top plan view of a conveyor system having the tool using vacuum retention of the present disclosure coupled thereto;

FIG. 13 of the drawings is a partial side elevational view of the conveyor system having the tool using vacuum retention of the present disclosure coupled thereto; and

FIG. 14 of the drawings is a partial end elevational view of the conveyor system having the tool using vacuum retention of the present disclosure coupled thereto.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of some embodiments of the invention, and some of the components may have been distorted from actual scale for purposes of pictorial clarity.

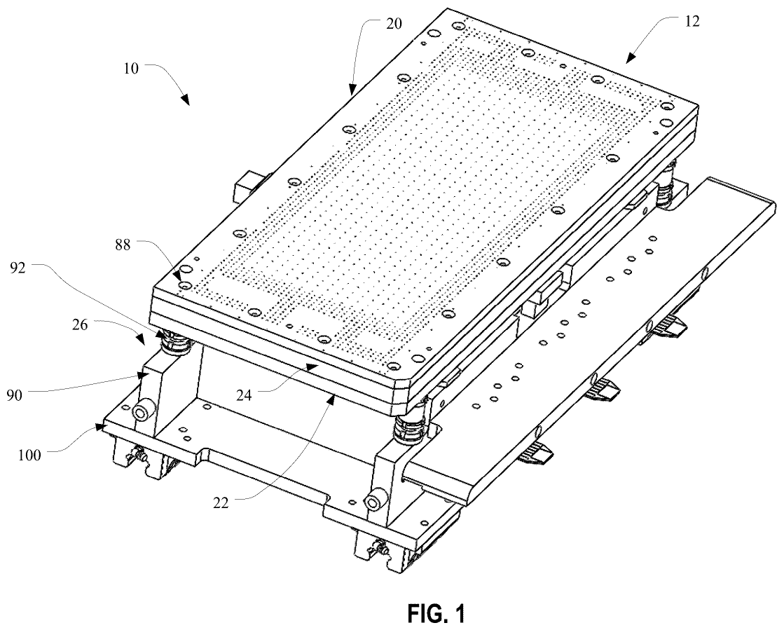

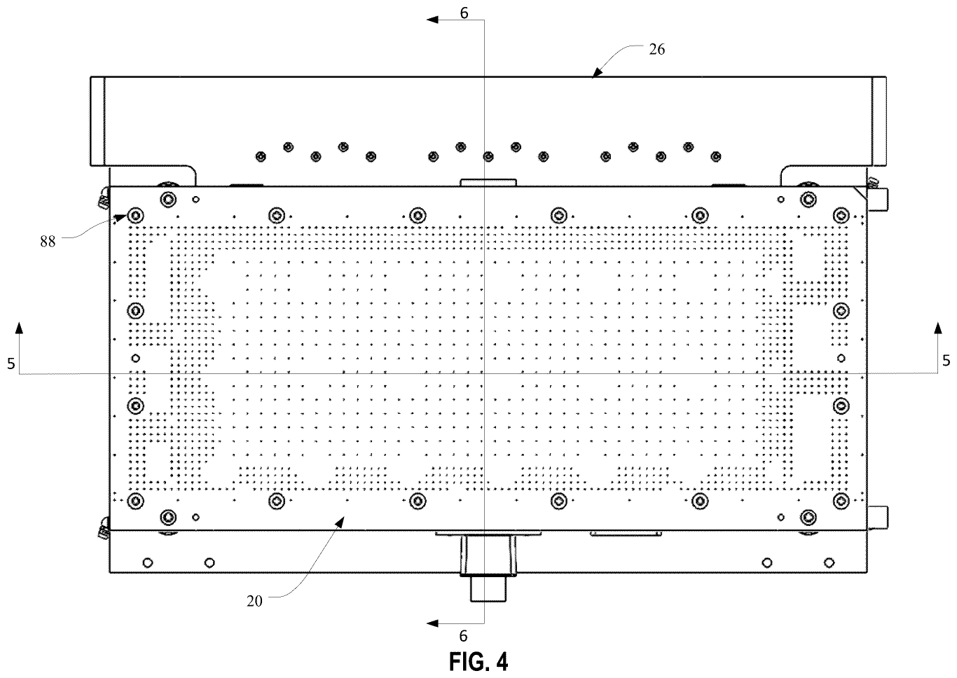

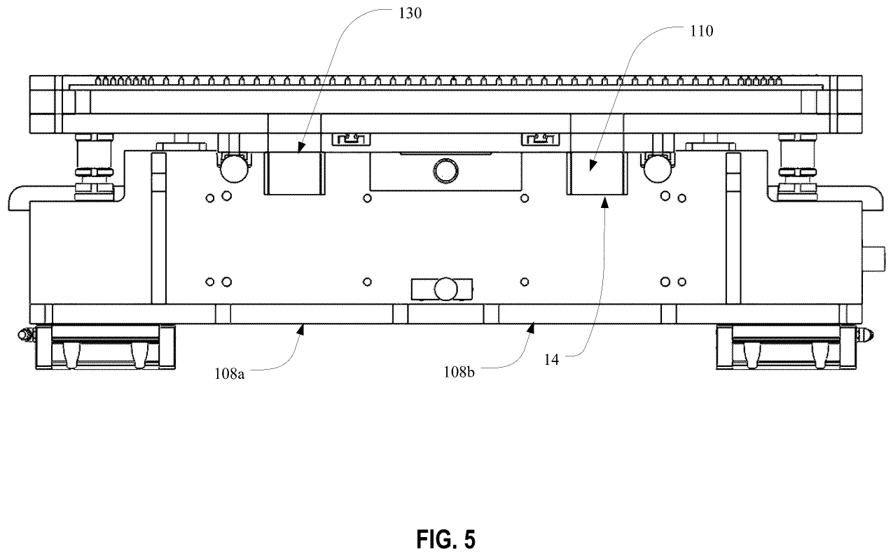

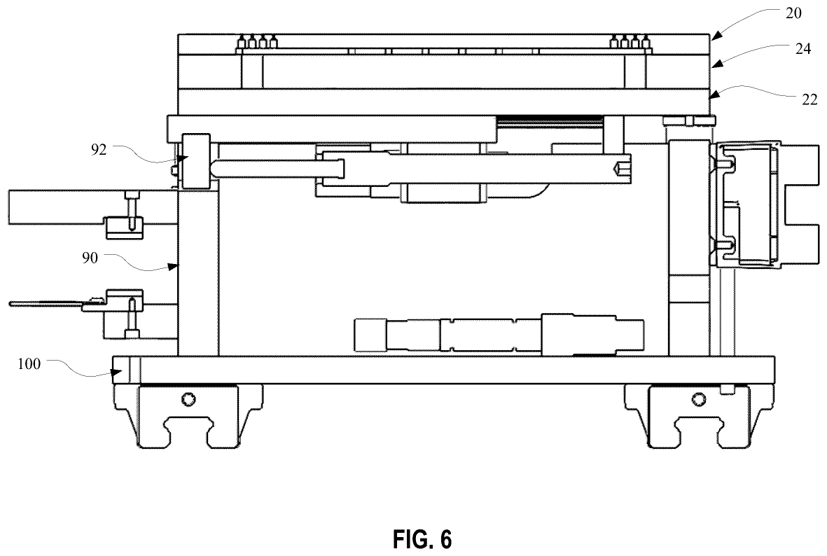

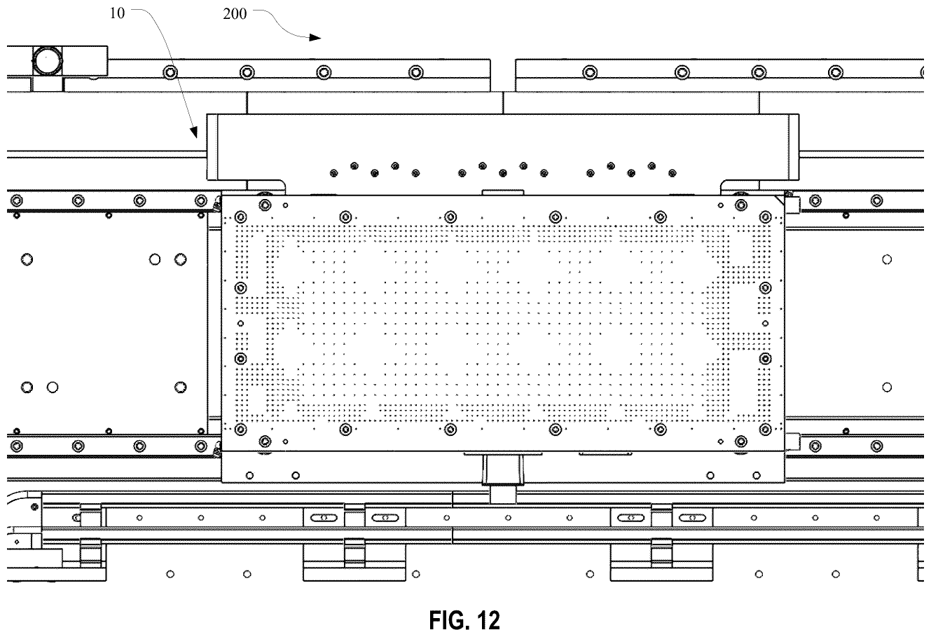

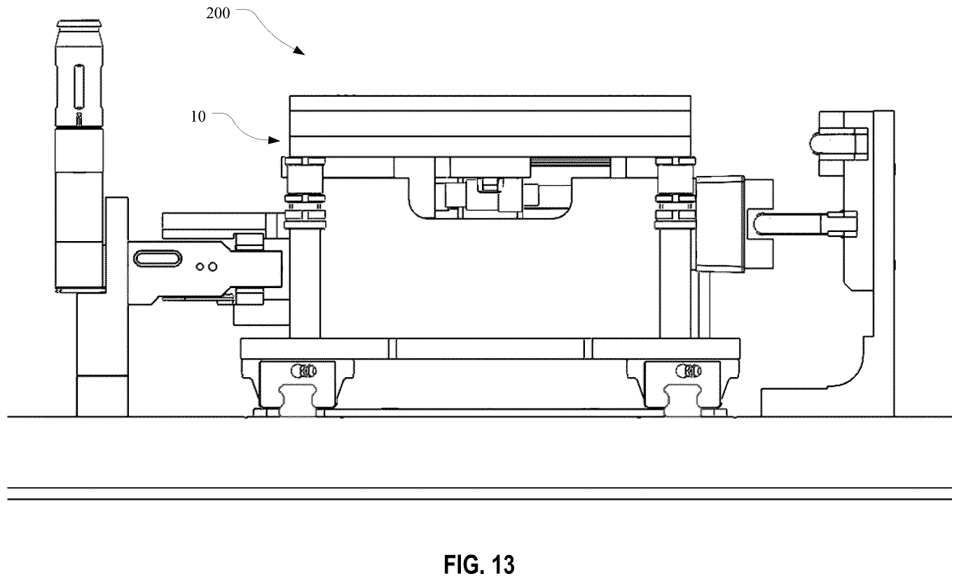

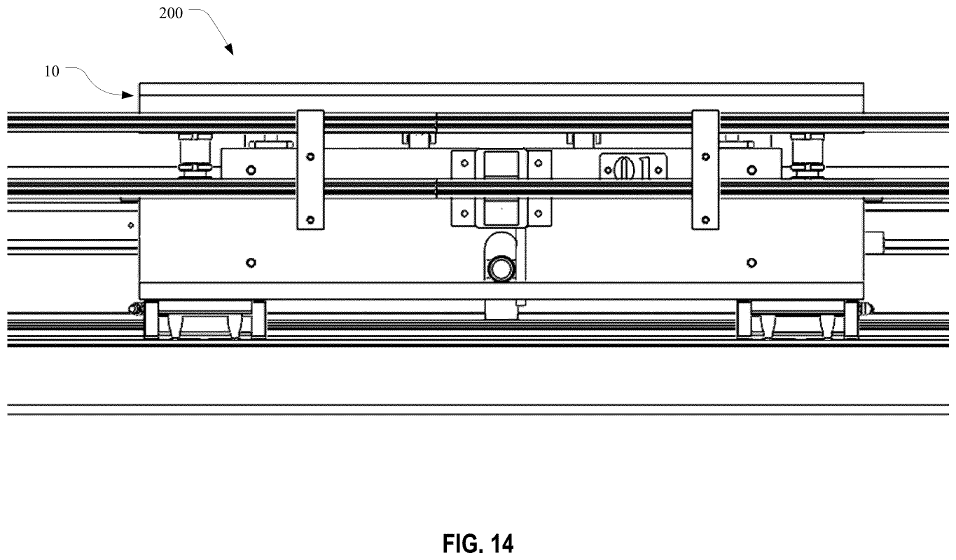

Referring now to the drawings and in particular to FIGS. 1 through 3, and 4 through 6, a tool using vacuum retention is shown generally as 10. The tool 10 can be utilized with a conveyor system, such as conveyor system 200 (FIGS. 12 through 14), utilizing relatively low wattage no cable technologies, which wirelessly transmit power from a conveyor base to tools that may be attached to the conveyor. At the same time, it will be understood that the disclosure and the tool are not limited to use with a conveyor system (e.g., in some embodiments, it may instead be mounted to a robotic arm as an end of arm tool), or a conveyor system that utilizes a wireless power transmission to the tool.

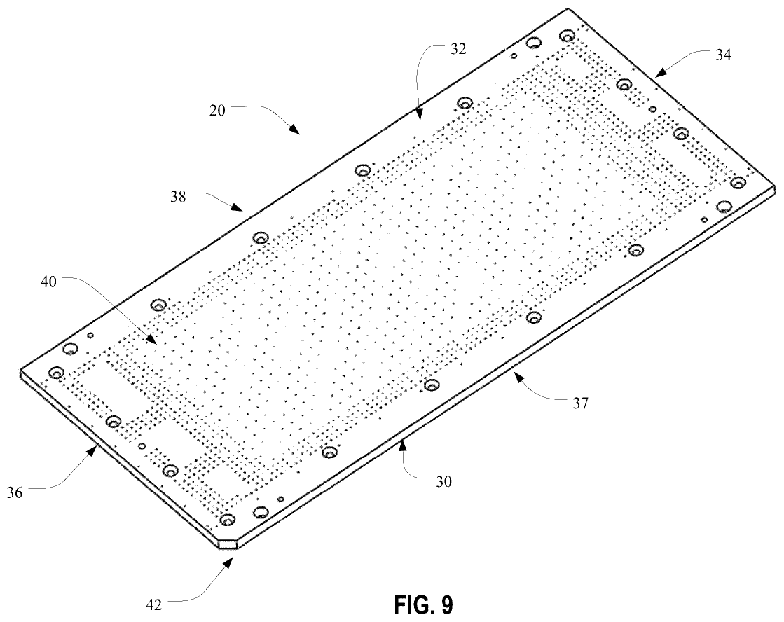

The tool is shown as comprising housing 12 and fan assembly 14. The housing 12 includes part holding plate (also referred to as vacuum plate) 20, back plate 22, spacer plate 24 and mounting assembly 26. With further reference to FIG. 9, the part holding plate 20 includes inner surface 30, outer surface 32, first side 34, second side 36, front end 37 and back end 38. The inner and outer surfaces 30, 32 are generally planar and generally parallel to each other defining a substantially uniform thickness to the part holding plate 20. It is contemplated that the inner and outer surfaces may be convex or concave as well, or that the surfaces may include surface variations. A plurality of openings 40 extend through the part holding plate generally perpendicular to the inner surface 30, while other configurations, such as oblique orientations are contemplated. In the configuration shown, the openings are spaced apart, sized and patterned to achieve a vacuum attachment to an outside component (not shown). It will be understood that the position, size as well as absolute and relative orientation and position can be varied depending on the shape, size, weight, composition, among other parameters, of the outside component that is to be picked.

Outside component may be understood as comprising any component (e.g., a workpiece, part, object, etc.) that is not part of the tool 10 itself (or conveyor system 20) but instead a component that is manipulated by the tool. Outside component can include, for example, and without limitation, layers of material that can be utilized in association with fuel cell production, such as, for example, the membrane electrode assembly (MEA), gas diffusion layers (GDL) among others, as well as subassemblies and components thereof. Other non-limiting examples of outside components include thin and/or flexible material, such as plastics, glass or textiles. In some implementations, the outside component can be 100 microns or thinner (e.g., in the range of 20-50 microns).

Generally, holding plate 20 has a rectangular configuration such that one of the parallel pairs of sides is defined by first side 34 and second side 36, and the other of the parallel pairs of sides is defined by front end 37 and back end 38. Together the first side, second side, front end and back end collectively define outer perimeter 42. It will be understood that other shapes are contemplated, such as, for example, other quadrilaterals, polygons, circles, ovals, ellipses, and arbitrary configurations. In some configurations of the housing, one or more templates can be affixed to the holding plate to cover some of the openings to define a shape that generally corresponds to the outside component to be picked. In other configurations of the housing, multiple holding plates may be utilized with the outermost holding plate having a plurality of openings in a pattern defining a shape that generally corresponds to the outside component to be picked. In the configuration shown, the holding plate comprises a metal member, such as, an aluminum alloy, while other materials are contemplated for use.

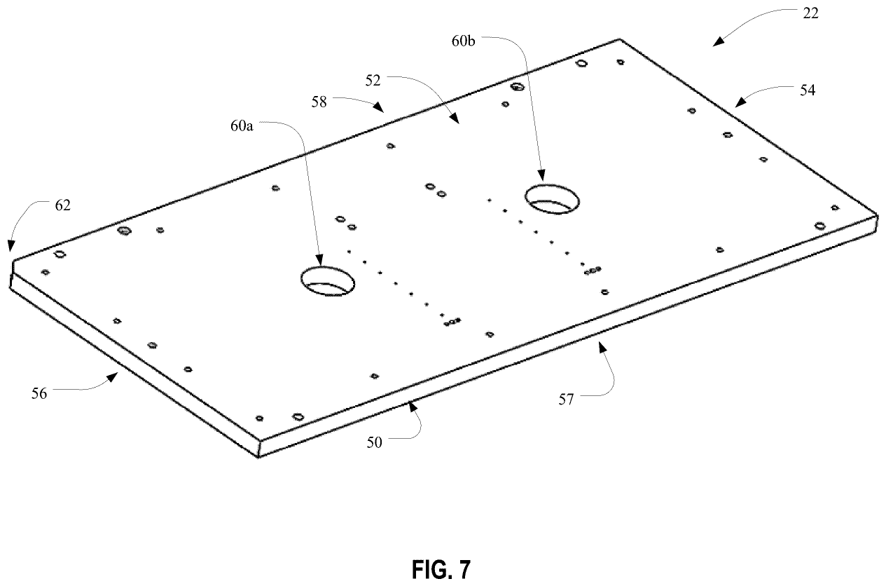

Referring again to FIGS. 1 through 6, and with further reference to FIG. 7, back plate 22 includes inner surface 50, outer surface 52, first side 54, second side 56, front end 57 and back end 58. The back plate, similar to the front plate, preferably comprises a substantially uniform thickness such that the inner and outer surfaces 50, 52 are generally parallel to each other and each generally planar. It is contemplated that the inner and outer surfaces may be convex or concave as well, or that the surfaces may include surface variations.

Fan openings, such as fan openings 60a, 60b may be formed through the back plate. In the configuration shown, a pair of fan openings are positioned in a spaced apart orientation relative to each other. In the configuration shown, the fan openings 60a, 60b are substantially uniform in cross-sectional configuration, and generally perpendicular to the inner surface 50. In other configurations, it may be desirable to alter the cross-sectional configuration at either of the surfaces or therebetween.

In the configuration shown, first side 54, second side 56, front end 57 and back end 58 form a generally rectangular configuration, generally corresponding to the shape of the part holding plate 20. The first side, second side, front end and back end collectively form the outer perimeter 62 of the back plate. Of course, variations are contemplated, as such variations are contemplated with the part holding plate. It will be understood that in other configurations, the part holding plate and the back plate may be of different shapes, sizes and configurations. As with the part holding plate, the back plate may likewise comprise a metal material, such as an aluminum alloy.

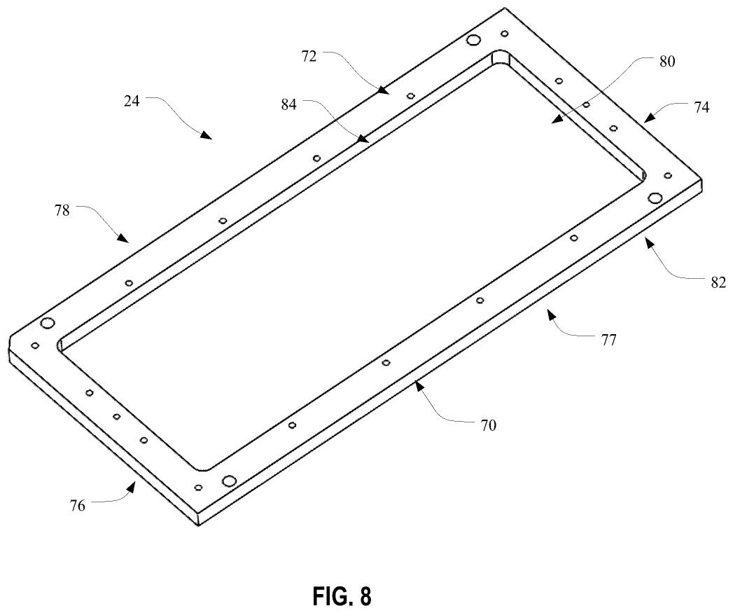

Spacer plate 24 is shown in greater detail in FIG. 8 as comprising inner surface 70, outer surface 72, first side 74, second side 76, front end 77 and back end 78. In the configuration shown, the inner and outer surfaces are substantially parallel to each other and substantially planar. The first side, second side, front end and back end collectively form outer perimeter 82, which in the configuration shown, corresponds to the outer perimeter of each of the part holding plate and the back plate, while variations are contemplated.

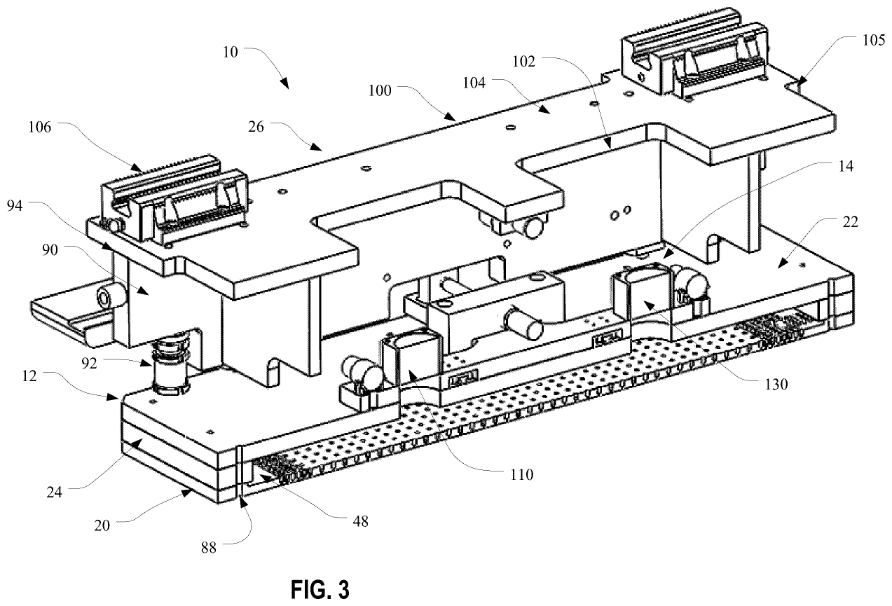

With reference to FIG. 8, central opening 80 is defined within the spacer plate, further defining a central perimeter 84. With further reference to FIGS. 3 through 6, the spacer plate 24 is sandwiched between the part holding plate 20 and the back plate 22 to collectively define cavity 48 (also sometimes referred to as a plenum), in, preferably, sealed engagement. Ingress to and egress from the cavity 48 is achieved through the openings 40 on the part holding plate 20 and through the fan openings 60a, 60b. Thus, the central perimeter preferably lies within the footprint of each of the inner surface 50 of the back plate 22 and the inner surface 30 of the part holding plate 20, so as to sealingly engage therewith.

Referring again to FIGS. 1 through 6, a plurality of fasteners 88 can be utilized to attach the part holding plate 20 to the back plate 22, sandwiching the spacer plate 24 therebetween. It will be understood that gaskets, sealants and the like may be utilized to provide a sealed coupling between the spacer plate 24 and the back plate 22 to one side and the part holding plate 20 to the other side. In the configuration shown, a total of 16 fasteners extend about the perimeter of the housing, in a generally evenly spaced apart configuration. Of course, other configurations are contemplated.

In the configuration shown, each of the part holding plate, back plate and spacer plate have a corresponding outer perimeter such that they appear as a stack. It will be understood that each may have the same thickness, or the thicknesses may be varied. Further, while a single spacer plate is shown, it will be understood that multiple spacer plates may be utilized. Furthermore, each of the part holding plate, the back plate and the spacer plate are shown as being a single integrally formed member, it is contemplated that these may comprise multiple members.

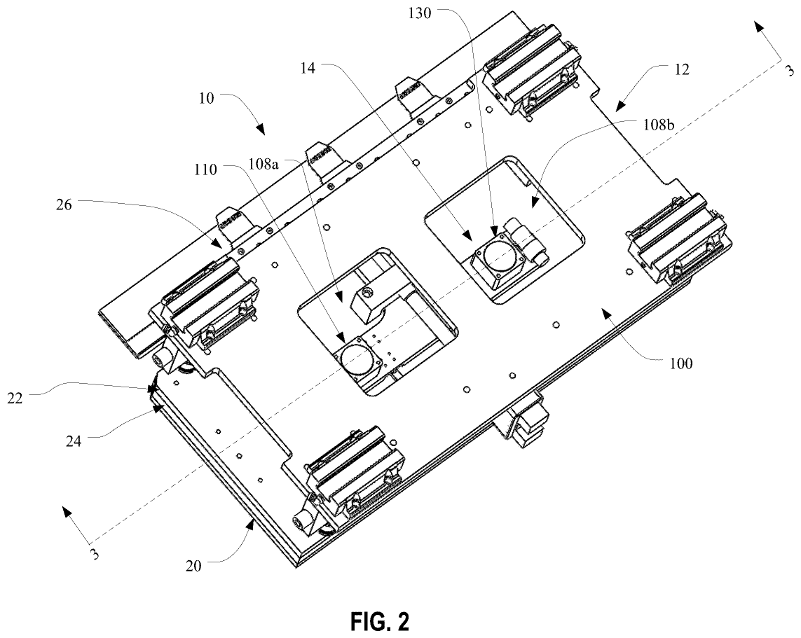

Mounting assembly 26 is shown in FIGS. 2 through 6 as comprising mounting spacer 90 (also referred to as riser) and mounting plate 100. Mounting plate 100 is shown as comprising inner surface 102 and outer surface 104 defining outer perimeter 105. In the configuration shown, the mounting plate is a generally rectangular cubic configuration and comprises a pair of openings 108a, 108b overlying the fan openings 60a, 60b on the back plate 22. In the configuration shown, the mounting plate is formed from a metal member, such as from an aluminum alloy. Of course, other shapes and sizes are likewise contemplated for the mounting plate and the pair of openings, as are different materials.

Mounting spacer 90 of the mounting assembly 26 is positioned between the inner surface 102 of the mounting plate and the back plate 22. The mounting spacer is mounted to the back plate 22 through a plurality of fasteners 92, which, are positioned in the corners thereof. In the configuration shown, leveling sets are used as fasteners to provide precise leveling and alignment between the plate assembly comprising the back plate 22, spacer plate 24 and part holding plate 20 and the mounting plate 100.

Attachment means, such as fasteners or clamps 106 as in the configuration shown, may be provided on the outer surface 104 of the mounting plate 100 to facilitate attachment of the tool 10 to other structures. It is contemplated that the mounting assembly may comprise a different structure that is suitable for attachment to an outside structure. Additionally, it is contemplated that the mounting assembly may be integrated with the back plate, for example. The disclosure is not limited to any particular mounting assembly configuration, nor any particular number of components or the like to be associated therewith. For example, the mounting assembly 26 may facilitate the attachment to a structure of a movable component that is to translate along a conveyor. In other configurations, the mounting assembly 26 may be configured to fixedly mount the housing to an outside structure that may remain stationary, or to a structure that may be movable, such as the end of a robotic arm, among others.

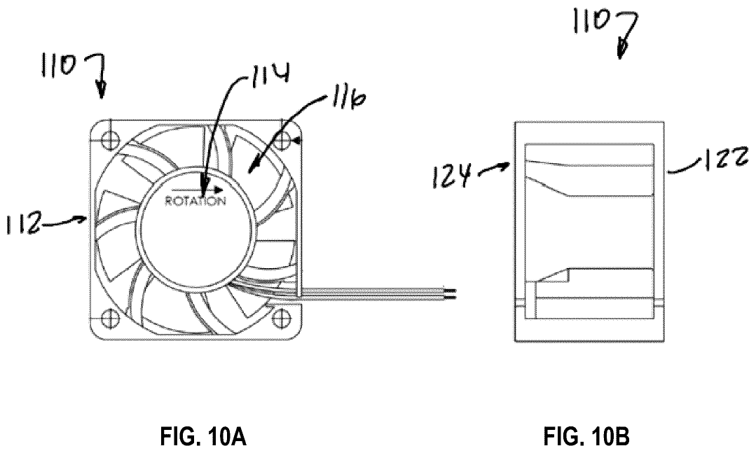

Fan assembly 14 is shown in FIGS. 2, 3 and 5 as comprising first fan 110 and second fan 130. The first fan and the second fan are substantially identical in structure, and, as such, first fan 110 will be described with the understanding that the second fan is substantially identical thereto. Reference numbers referring to corresponding structures on second fan 130 will have the same reference number as those on the first fan, augmented by a prime(′). With further reference to FIGS. 10a and 10b, the first fan 110 includes a frame 112, motor 114 and blades 116. The fan further defines an inlet side 122 and an outlet side 124.

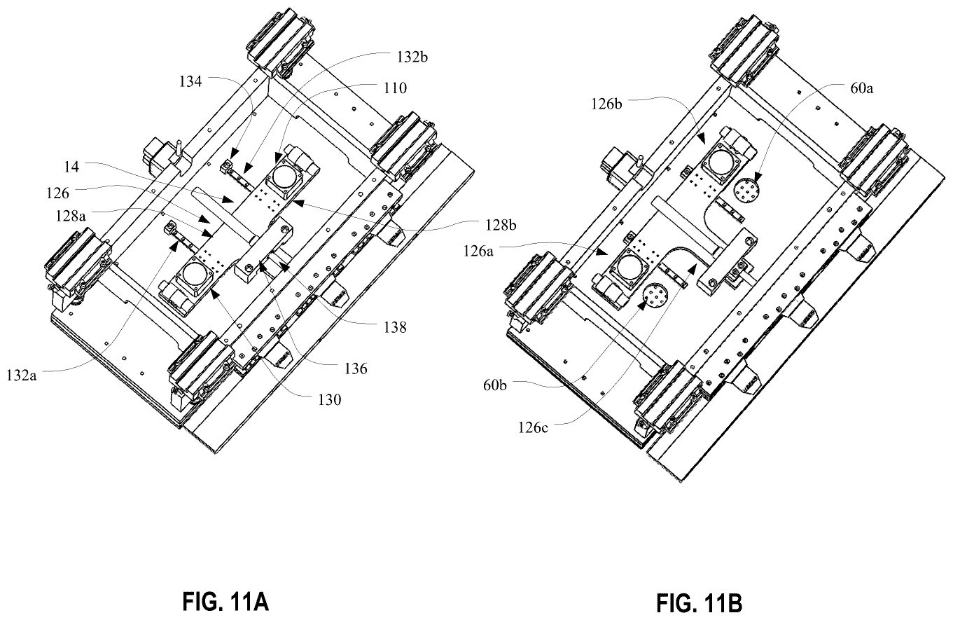

With reference to FIGS. 11A and 11B, the fan assembly includes fan shuttle 126 slidably mounted on a pair of guide rails 132a, 132b on the back plate 22. The fan shuttle 126 is generally in the shape of a “T” with two oppositely directed lateral arms and a stem. The terminal end of the stem 126c of the “T” is coupled to a spring mount block 136. Each arm 126a, 126b, on the inner surface of the shuttle, includes a corresponding structure such as brackets or plates slidably connected to a corresponding guide rail 132a, 132b. The pair of guide rails are fixed to the outer surface 52 of the back plate 22 with a plurality of fasteners. The guide rails are spaced apart and run parallel to each other, extending in a direction generally parallel to the stem and generally perpendicular to the direction of the lateral arms. An end stop 134 distal to the terminal end of the stem is located on each guide rail. On the outer surface of arm 126a, the frame of the first fan 110 is mounted over an opening corresponding to the fan opening 60a so as to have the inlet side 122 overlying fan opening 60a (when in the extended position, as further described below). Similarly, the frame of the second fan 130 is mounted on the outer surface of the arm 126b over an opening corresponding to the fan opening 60b so as to have inlet side 122′ overlying fan opening 60b (when in the extended position, as further described below). The fans can be wired, preferably to DC power.

A spring-loaded device 138 such as a spring plunger (e.g., spring plunger manufactured by Halder, Inc. of New Berlin, WI) is positioned within the movable spring mount block 136. With the application of a contact force, the spring plunger is configured to push against a surface that is proximal to the terminal stem end and abuts the back plate, causing the spring plunger to retract and compress the spring therein. When the contact force is removed, the force from the compressed spring causes the spring mount block and the fan shuttle coupled to the block to move in a direction distal from the terminal stem end. The fan shuttle as configured can move along the guide rails between an extended or closed position (as shown in FIG. 11A) and a retracted or open position (as shown in FIG. 11B). As shown, in the extended position, the fans are positioned over the fan openings 60a, 60b and are in fluid communication with one another. In this position, the fans suction the air out of the plenum to create sufficient suction force to pick up and retain an outside component. In the retracted position, the fans are displaced from the fan openings and are out of fluid communication with one another. In this position, the air quickly enters the plenum to remove the suction force to release the outside component. It is contemplated that the fan shuttle may be moved in and out of position using any known actuator such as, but not limited to, hydraulic, pneumatic (e.g., air cylinder) or electronic (e.g., electric solenoids) actuator, cam mechanism and/or the like.

While in the configuration shown in FIGS. 11a and 11b, both fans are mounted on the fan shuttle so that the displacement of the pair of fans occurs simultaneously, it will be understood that in some other configurations, each fan may be mounted on a separate fan shuttle operating in a synchronized fashion so that the fans are placed in and out of position substantially simultaneously or, in some implementations, placed in and/or out of position according to a predetermined delay that may facilitate pickup and/or release of some types of outside components). In such implementations wherein the fans are mounted on separate fan shuttles, the fan shuttles may be configured such that the axes along which the respective fans move in and out of position are not necessarily parallel to each other (e.g., these axes may be orthogonal, or at another angle, to each other).

Accordingly, it will be understood that the fan assembly illustrated in FIGS. 11a and 11b is configured to provide for the fans to be movable relative to the tool housing (and thus movable relative to the fan openings formed in the housing) to selectively locate the fans in (i) a first position over the fan opening such that the tool can engage an outside component using vacuum retention, and (ii) a second position sufficiently (e.g., partially or completely) displaced from the fan opening such that an outside object previously engaged by vacuum retention using the fans will be disengaged or released from the tool. In addition, as shown, the illustrative fan assembly is configured such that movement of each fan between these first and second positions is along an axis that is substantially parallel to a plane of the tool surface upon which the fan assembly is mounted. It will be further understood that various alternative fan assembly configurations (e.g., including fan assembly movement mechanisms) may be implemented to provide for one or more fans to be movable relative to the tool housing (and thus movable relative to the fan openings formed therein) to selectively locate the one or more fans to provide for selectively engaging and disengaging an outside component.

In the configuration shown, it is contemplated to couple the tool 10 to a conveyor system that utilizes relatively low wattage no cable technologies. Such technologies are typically limited to 200 W or less, and in some cases 75 W peak power with 35 W continuous power. Of course, the disclosure is not limited to any particular power consumption of the fans, or to any particular types of fans, to use with relatively low wattage no cable technologies or the like. While two fans shown are generally mirror images of each other about an axis bisecting the shorter sides of the mounting plate 100, it will be understood that a single fan can be utilized for multiple openings (where the openings may be linked with a manifold or the like), or that multiple fans may be associated with a single opening. It is further contemplated that more than two openings may be defined in the back plate 22 and additional fans may be utilized (again, in any ratio of fans to openings).

In the configuration shown, the first fan and the second fan comprise a DC fan model number OD4028-24HBXE manufactured under the mark Orion Fans, sold by Knight Electronics, Inc. of Dallas Texas. Such a fan can be operated at between 14 and 26 Volts, and has a max power input of 15.6 Watts. Such a fan rotates at 22750 RPM, with a Max Airflow of 31.5 CFM and a Max Static Pressure of 3.0 in H₂O. Of course, other fans are contemplated for use, while it has been found that the fan set forth herein generates sufficient static pressure to retain the outside component that is to be picked up, dropped off and/or otherwise retained.

With reference to FIGS. 1 through 6, to assemble the tool, the components are first provided. Housing 12 is formed by placing the spacer plate 24 between inner surface 30 of the part holding plate 20 and the inner surface 50 of the back plate 22, such that the inner surface 70 of the spacer plate 24 meets inner surface 30 and that the outer surface 72 of the spacer plate 24 meets inner surface 50. Fasteners 88 can be extended into and/or through the part holding plate 20, spacer plate 24 and back plate 22 to sandwich the spacer plate between the part holding plate 20 and the back plate 22. Additional gaskets, sealants or the like may be provided to minimize and/or eliminate leaks therebetween. When assembled, the three components collectively define the plenum 48.

Next, the mounting assembly may be attached to the back plate 22. In particular, the mounting spacer 90 is positioned so that the inner surface 102 of mounting plate 100 faces the outer surface 52 of the back plate 22. Subsequently, the mounting plate 100 is placed on the outer surface 94 of the mounting spacer and aligned. Fasteners may be extended through openings in the mounting plate and the mounting spacer to join the mounting spacer to the mounting plate. Fasteners such as leveling sets may be used to align and level the mounting assembly with the back plate 22.

Similarly, first fan 110 of the fan assembly is attached to the fan shuttle and positioned over the fan opening 60a, in such an orientation with fasteners. It will be understood that gaskets, sealants or the like can be utilized to minimize any leaking of air therebetween. Similarly, second fan 130 is attached to the fan shuttle and positioned in a corresponding manner over fan opening 60b. As such, in an extended position, the fans are in fluid communication with plenum 48, and configured to withdraw air (or supply air) to cavity 48 when actuated The fans may be electrically coupled to a power supply that is suitably positioned (i.e., a power supply that is powering, for example, the conveyor components wirelessly or in a wired configuration), a power supply provided by, for example, by a robot (at the end of the arm or otherwise). It is contemplated that power may be provided on the housing itself through any one of a battery, fuel cell, or the like. Advantageously, the first fan and the second fan develop what has been found to be sufficient static pressure while utilizing a relatively low power requirement. Similarly, in a retracted position, the fans are out of fluid communication with plenum 48, thereby removing vacuum pressure.

In some configurations, the mounting assembly 26 can be modified so as to be attachable to a conveyor system 200. One such configuration is shown in FIGS. 11 through 13. Any number of different conveyor assemblies are contemplated, such as, for example, and without limitation, a linear product transport system, including such system sold as the XTS modular system, which may utilize contactless power supply such as the CPS140, as provided by Vahle Inc. of Katy, Texas, the NCT (no cable technology), as provided by Beckhoff Automation LLC of Savage, Minnesota or any other induction based power supply solutions. As set forth above, the fan assembly may be coupled to a contactless power supply system.

In operation, tool 10 can be used to pick up, drop off and/or otherwise retain, for example, various outside components. As set forth above, in some configurations, the outside components may comprise layers of material that can be utilized in association with fuel cell production, such as, for example, the membrane electrode assembly (MEA), gas diffusion layers (GDL) among others, as well as subassemblies and components thereof. Of course, the tool is not limited to use in association with fuel cells, or in association with any particular outside components, and the foregoing are disclosed for exemplary purposes and not so as to be limiting.

In such a configuration, to initially capture the outside component, one or both of the tool and the outside component can be directed toward each so that at least a portion of the outside component is aligned with or positioned within the footprint of the outer surface 32 part holding plate 20. The fan shuttle is in an extended position with at least one of the fans of the fan assembly, and preferably both of the fans in the configuration shown, is activated, as the back plate reaches the outside component. As the air is being removed from within cavity 48 by the fan(s), a suction effect is generated at the openings 40, and the outside component is urged toward the outer surface 32 of the part holding plate in releasable coupling through vacuum retention. Additionally, due to the continued operation of the fan(s), the outside component remains in releasable coupling and is generally stationary relative to the outer surface 32 of the holding plate and is retained due to the vacuum that is being formed within the cavity.

Preferably, each of the openings 40 of the part holding plate 20 is overlayed with the outside component. However, in some configurations, some of the openings may remain uncovered, while the vacuum force may be sufficient to retain the outside component even with some of the openings remaining uncovered.

With the outside component releasably coupled to the tool, the tool can be moved with the outside component as desired. At such time that release and/or transfer of the outside component to a second surface is desired, the tool can be positioned and aligned with the second surface as desired. Once fully positioned and aligned, actuation force can be applied to the air shuttle to move the fans in and out of position. For example, actuation force, such as from an air cylinder fixed mounted on the conveyor system, can be applied to the fan shuttle (e.g., via the spring block mount) to cause contact pressure to be applied to the spring plunger compressing the internal spring and retracting the plunger inside. When the actuation force is removed, the contact pressure on the spring plunger is released resulting in a reaction force that causes the fan shuttle to slide along the guide rails in the direction towards the end stops displacing the fans from the fan openings. The displacement results in a fast removal of the suction effect due to readjustment of the pressure between the cavity and the ambient and the outside component releases from the tool through, for example, simple gravity, or otherwise. If the fans are stopped in position (i.e., over the fan openings), removal of the vacuum force and therefore release of the outside component occurs at a slower speed because inertia causes the fan blades to continue to rotate for some time. Reversing the fans may to some extent improve the speed at which the pressure within the cavity is sufficiently increased to allow for release of the outside component. However, by shuttling the fans away from the fan openings, the speed is further improved allowing a relatively faster release of the outside component.

In addition to the speed at which outside parts can be picked up and released, the disclosed tool has many other advantages. For example, compared to the conventional methods of generating vacuum such as venturi vacuum generators or DC vacuum pumps which require compressed air source, too much electrical power and can be expensive, the disclosed tool creates vacuum using wirelessly powered and laterally actuated high static pressure fans and is cheaper to implement. The tool utilizes a simple mounting mechanism offering a lightweight solution which can be a key consideration in many applications. Furthermore, the fans provide a good balance between high static pressure and high flow so that outside components can be securely lifted.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. A tool utilizing vacuum retention comprising:
a housing, with the housing defining a plenum and including at least one fan opening and a surface comprising a plurality of openings configured to engage an outside component utilizing vacuum retention; and
at least one fan assembly mounted to the housing, the fan assembly comprising at least one fan mounted on a movable shuttle that is configured to position the at least one fan in fluid communication with the at least one fan opening to engage the outside component utilizing vacuum retention.

2. The tool of claim 1, wherein the movable shuttle is further configured to place the at least one fan out of fluid communication with the at least one fan opening to disengage the outside component.

3. The tool of claim 2, wherein the at least one fan is placed in and out of fluid communication with the at least one fan opening via lateral displacement.

4. The tool of claim 1, wherein the tool is movable during operation of the at least one fan.

5. The tool of claim 1, wherein the at least one fan is powered by wireless power transmission.

6. The tool of claim 1, wherein the plenum is defined by stacking a back plate having the at least one fan opening, a spacer plate and a part holding plate having the surface comprising the plurality of openings.

7. The tool of claim 6, wherein the movable shutter moves along a pair of guide rails in response to force exerted by an actuator, wherein the guide rails are spaced apart and mounted in parallel on an outer surface of the back plate.

8. The tool of claim 1, wherein the housing comprises a mounting assembly to facilitate attachment of the tool to an outside structure.

9. The tool of claim 8, wherein the outside structure is a conveyor system or end of a robotic arm.

10. The tool of claim 1, wherein the outside component is a thin material or textile.

11. A method of utilizing vacuum retention comprising:
generating vacuum through a vacuum plate with at least one fan mounted on a movable shuttle that is configured to position the at least one fan over at least one fan opening so that the at least one fan is in fluid communication with the at least one fan opening; and —retaining an outside component with the vacuum that is generated.

12. The method of claim 11, further comprising:
stopping vacuum generation through the vacuum plate by configuring the movable shuttle to position the at least one fan out of fluid communication with the at least one fan opening; and
releasing the outside component from vacuum plate.

13. The method of claim 12, wherein the at least one fan is placed in and out of fluid communication with the at least one fan opening via lateral displacement.

14. The method of claim 12, wherein the vacuum plate includes a plurality of openings and is a part of a housing that comprises a plenum defined by a spacer plate sandwiched in between the vacuum plate and a back plate having the at least one fan opening and a mounting assembly.

15. The method of claim 14, wherein the movable shutter moves along a pair of guide rails spaced apart and mounted on an outer surface of the back plate in response to force exerted by an actuator.

16. The method of claim 14, further comprising attaching the housing to an outside structure using the mounting assembly, wherein the outside structure is a conveyor system or end of a robotic arm.

17. The method of claim 14, wherein the housing is movable during operation of the at least one fan.

18. The method of claim 12, wherein the at least one fan is powered by wireless power transmission.

19. The method of claim 12, wherein the outside component is a thin material or textile.

20. A conveyor system utilizing a tool utilizing vacuum retention comprising:
a conveyor; and
the tool utilizing vacuum retention movable along the conveyor, the tool comprising a housing and a movable fan assembly having at least one fan, wherein the movable fan assembly is configured to move the at least one fan in fluid communication with at least one fan opening on the housing to generate vacuum to pick up and retain an outside component on a surface of the housing and out of fluid communication with the at least one fan opening on the housing to remove the vacuum to release the outside component from the surface of the housing.
